(19) United States
(12) Patent Application Publication
(10) Pub. No.: US 2015/0018579 A1
(43) Pub. Date: Jan. 15, 2015

(54) SYNTHESIS OF HIGH PURITY DMT-C3-DISULFIDE PHOSPHORAMIDITE

(71) Applicants: Suresh C. Srivastava, Burlington, MA (US); Santhosh K. Thatikonda, Woburn, MA (US); Praveen Shukla, Burlington, MA (US); Sant Kumar Srivastav, Burlington, MA (US)

(72) Inventors: Suresh C. Srivastava, Burlington, MA (US); Santhosh K. Thatikonda, Woburn, MA (US); Praveen Shukla, Burlington, MA (US); Sant Kumar Srivastav, Burlington, MA (US)

(21) Appl. No.: 14/380,640

(22) PCT Filed: Feb. 22, 2012
(86) PCT No.: PCT/US2012/000103

§ 371 Date: Aug. 22, 2014

(51) Int. Cl. C07F 9/22

(52) U.S. Cl. CPC C07F 9/222
USPC 568/15

(57) ABSTRACT

The 5′ and 3′-thiol modified oligonucleotides are attractive tools with a vast number of potential applications in the field of nucleic acid chemistry. There is a strong interest in developing new disulfide compounds or to optimize synthesis of existing disulfide modifiers, which are efficient in generating the 3′- or 5′-end reactive thiol group. Various synthetic protocols have been employed to synthesize pure 3-((3-(bis(4-dimethoxytrityl)propyl)di-sulfanyl)propyl 2-cyanoethyl diisopropylphosphoramidite (compound 2) starting from 3-(dimethoxytrityl)propyl)disulfanyl)pro-pan-1-ol, (compound 1). Herein, we describe an efficient, reproducible synthetic and purification protocol for target compound 2 from the compound 1. It is noteworthy that our reaction conditions were reproducible even at multi-gram scale (27 g) with a purity level as achieved in a small scale.

### FIELD OF THE INVENTION

This invention generally relates to the field of nucleic acid chemistry. In particular, the present invention relates to optimized synthesis of C-3 disulfide phosphoramidites.

### BACKGROUND OF THE INVENTION & TECHNICAL PROBLEM

The Thiol group (R-SH) can be introduced either at 3′- or 5′-end of oligonucleotides by incorporating the thiol modification during solid-phase phosphoramidite oligonucleotide synthesis. Commonly either disulfide or S-trityl protection [Connolly, B. A.; Rider, P. Nucleic Acids Res. 1985 13, 4485] stratagies are used to block the nucleophilicity of thiols during oligoinucleotide synthesis. Free thiol group from the disulfide is generated by treating oligo with reducing agent such as dithiothreitol (DTT). In other process developed for introduction of free SH group, S-trityl group is cleaved by reaction with silver nitrate to generate free SH group. The later process generates excess silver nitrate which is then removed by treatment with DTT. The DTT silver nitrate results in an insoluble complex which then tends to stick with oligonucleotide thereby causing significant loss of oligonucleotide. Hence, generally during this modification the yield of modified oligonucleotide are lower in case of S-trityl strategy compared to the disulfide strategy. So there is strong need to develop new disulfide compounds or optimize the synthesis of existing disulfide modifiers, which are efficient in generating the 3′- or 5′-end reactive thiol group.

One of the key applications of disulfide linker was reported by R L Letsinger and coworkes, Bioconjugate Chem., 2000, 11(2), 289-91, and utilized assembly of oligonucleotide, disulfide linker and gold nano particles to develop gold nano-particle based nucleic acid detection system. DNA functionalized gold nanoparticles have since become widely used building blocks in key nucleic acid based assembly strategies, bio diagnostics and nano technology based therapeutics, C A., Merkins, R. L. Letsinger, R. C. Mucic, J. J. Storhoff, Nature, 1996, 382, 607; S. J. Hurst, H. D. Hill, C.A., Mirkin., J. Am. Chem. Soc., 2008, 130, 12192.

Synthesis of C-3 disulfide phosphoramidite compound 2 has recently been reported very briefly by Yosuke Taniguchia et. al. [Taniguchi, Nitta, A., Park, S. M., Kohara, A., Uzu, T., Sasaki, S. Bioorg. Med. Chem. 2010, 18, 8614].

The reported synthetic protocol was not reproducible in generating the target compound 2 and purification procedure was not reported and consistently generated highly impure compound 2. Our goal was therefore set to develop a process of optimized synthesis of (3-(bis(4-dimethoxytrityl)propyl)disulfanyl)propyl 2-cyanoethyl diisopropylphosphoramidite, compound 2 (scheme 1) of high purity (>94%).

Our further goal was to produce this class of compounds in multi-gram or further large scales for commercial & for research and development in this very important area of oligonucleotide modification. We therefore carried out detailed investigation into the past strategies reported in literature and develop a new synthetic and purification method which gives the title compound 2 in a high purity.

Synthesis of phosphoramidite compound 2 has recently been reported by Yosuke Taniguchia et. al. [Taniguchi, Nitta, A., Park, S. M., Kohara, A., Uzu, T., Sasaki, S. Bioorg. Med. Chem. 2010, 18, 8614]. However, the purification of the compound 2 was not mentioned and reported ³¹P NMR purity was not satisfactory for the commercial use and to produce good quality the oligonucleotides. More ever, reported synthetic protocol was not reproducible in generating the target compound 2 in our hands. We therefore carried out detailed investigation into the past strategies reported in literature and develop a new synthetic and purification method which gives the title compound 2 in a high purity.

The synthesis of the 3-(dimethoxytrityl)propyl)disulfanyl)propan-1-ol compound 1 was performed according to the previously reported procedure [D. Pei, D. R. Corey and P. G. Schultz, Proc. Natl. Acad. Sci. USA, 1990, 87, 9858]. The optimized synthesis of 3-((3-(bis(4-dimethoxytrityl)propyl)disulfanyl)propyl 2-cyanoethyl diisopropylphosphoramidite compound 2 was achieved successfully a large number of reaction trials some of which are summarized in Table 1 and shown in Scheme 2. When we performed the reaction by standard phosphoramidite synthesis reaction protocol using 2-cyanoethyl N,N′-(diisopropyl)-phosphoramidochloridite and Hunig's base in an CH₃CN at room temperature (Entry 1, Table 1), to our surprise, we isolated substantial amounts of tentatively identified 3-(dimethoxytrityl)propane-1-thiol, compound 3 (Scheme 2, FIGS. 1-3) along with the minor quantities of corresponding phosphorothioamidite compound 4.

On the other hand, using alternate 2-cyanoethyl tetraisopropyl phosphoramidite reagent and N,N′-diisopropylamino tetrazolide as a catalyst (Entry 2, Table 1) resulted in clean formation of only the 3-(dimethoxytrityl)propane-phosphorothioamidite compound 3 (FIGS. 4-7) along with minor quantities of compound 2. ³¹P NMR of compound 3 (FIG. 5) displayed peak at 164 ppm, which confirms the phosphorothioamidite group [Sabbagh, G.; Fettes, K. J.; Gosain, R.; O'Neil, I. A.; Cosstick, R. Nucleic Acids Res. 2004, 32,495-501]. ¹H NMR, MS and ³¹P NMR were used to confirm the structures of compound 2 (FIGS. 1-3) and compound 3 (FIGS. 4-7).

Various other reaction conditions were used to synthesize the target phosphoramidite compound 2. We used several other organic bases such as 1-methyl imidazole (Entry 4, Table 1) or 2,4,6-trimethyl pyridine (Entry 5, Table 1) along with 2-cyanoethyl N,N′-(diisopropyl)-phosphoramidochloridite reagent in anhydrous THF. These reaction conditions did result in a formation of the desired phosphoramidite compound 2 along with the substantial amounts of compound 3 and compound 4 (Scheme 2). When we carried out a silica gel column chromatography to purify compound 2, we observed breakdown of compound 2 to compound 3. As a result we were unsuccessful in isolating pure fractions of the compound 2 in our hands. We also used dibutyldisulfide as a competitive oxidizing substance over starting disulfide using N,N′-(diisopropyl)-phosphoramidochloridite and Hunig's base and this procedure resulted in a mixture of compound 2, compound 3 and compound 4 (Entry 6, Table 1).

TABLE 1
Various reaction conditions for the synthesis of desired phosphoramidite,
compound 2

| Trial | | |
|---|---|---|
| 1 | Conditions | Compound |
| 1 | 2-cyanoethyl N,N′-(diisopropyl)- | 3 (substantial) |
| | phosphoramidochloridite, N,N-diisopropylethyl | and 4 (minor) |
| | amine, an CH₂Cl₂, rt. | |
| 2 | 2-cyanoethyl tetraisopropyl phosphoramidite, | 4 (major) and 3 |
| | N,N′-diisopropyl tetrazolide, An CH₃CN, rt. | (<5% on TLC) |
| 3 | 2-cyanoethyl N,N′-(diisopropyl)- | 2, 3 and 4 |
| | phosphoramidochloridite, N,N-diisopropylethyl | |
| | amine, an CH₂Cl₂, 0° C.. | |
| 4 | 2-cyanoethyl N,N′-(diisopropyl)- | 2, 3 and 4 |
| | phosphoramidochloridite, 1-methylimidazole, | |
| | 0° C., an THF. | |
| 5 | 2-cyanoethyl N,N′-(diisopropyl)- | 2, 3 and 4 |
| | phosphoramidochloridite, 2,4,6-trimethyl pyridine, | |
| | 0° C., an THF. | |
| 6 | 2-cyanoethyl N,N′-(diisopropyl)- | 2, 3 and 4 |
| | phosphoramidochloridite, N,N-diisopropylethyl | |
| | amine, dibutyl disulfide, an THF, 0° C. | |
| 7 | 2-cyanoethyl N,N′-(diisopropyl)- | |
| | phosphoramidochloridite, N,N-diisopropylethyl | 2 |
| | amine, an THF, 0° C.. Argon bubbling during the | |
| | reaction followed by the purification over short | |
| | pad of silica | |

for structure of compounds 2, 3 and 4 see scheme 2

Several disulfide based chemically modified gold nanoparticles and methods for use in detecting target molecules have been reported by a number of investigators. Thus Viswanadham Garimella et al., Patent application number; 20100075314, publication date: March 25, 2010. The report describes stable bioconjugate-nanoparticle probes which were used for detecting nucleic acids and other target analytes, e.g., proteins, and methods of preparing cyclic disulfide based probes. The reported probes of the general formula L-PO₂—O((-T-O—PO₂—O)ₘ—Zₙ)-biotin, used a steroid with a cyclic disulfide functional group and thymidine phosphate as point of attachment of the disulfide for application in nucleic avid chemistry broadly. The present invention can lead to modified gold nanoparticles with optimized and improved properties for nucleic acid probes, diagnostics and therapeutics.

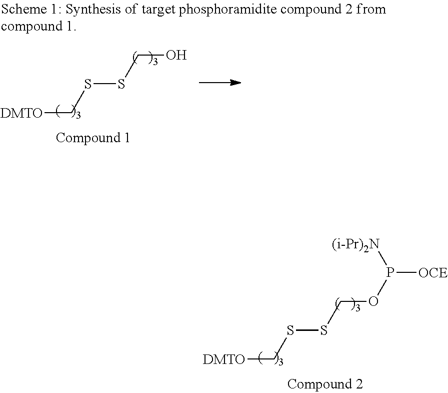

### SUMMARY OF THE INVENTION AND INDUSTRIAL APPLICABILITY

The present invention discloses optimized synthesis of 3-((3-(bis(4-dimethoxytrityl)propyl)disulfanyl)propyl 2-cyanoethyl diisopropylphosphoramidite, compound 2 (scheme 1), which is useful in generating an important class of thiol-C-3 modified oligonucleotides, with the high purity (>94%).

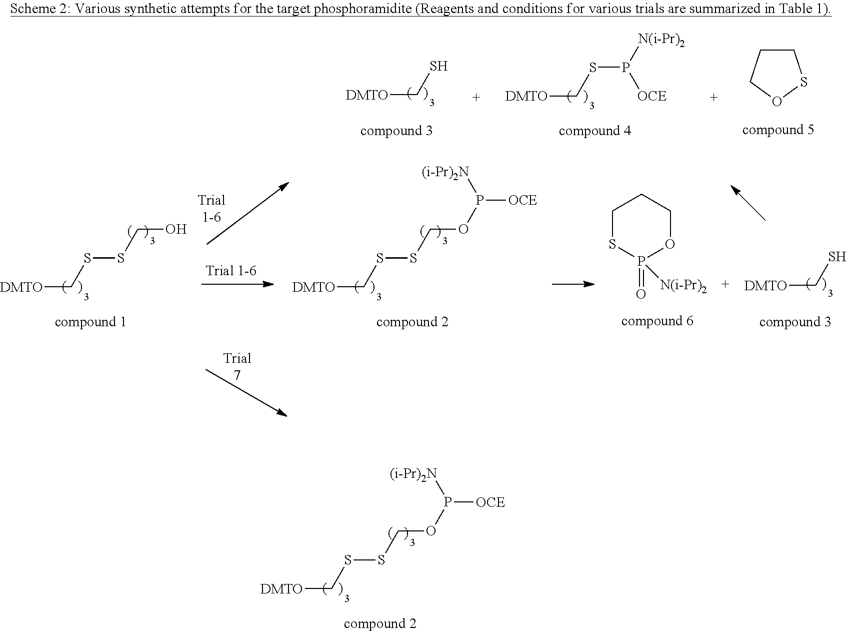

The thiol group at 3′ or 5′-end of a oligonucleotide enables covalent attachment of a variety of ligands by making reversible disulfide bonds (ligand-S—S-oligo) or irreversible bonds with a variety of activated accepting groups. Hence, thiol-modified oligonucleotides are attractive tools and have vast number of uses such as, reactions with various fluorophores, biotin and biologically important molecules which contain an α,β-unsaturated ketone, maleimide, iodoacetamide, bromide, iodide, or other Michael acceptors.

In addition, these terminal thiol oligonucleotides can also be used for reaction with cysteines in proteins to form disulfide bonds and also for attaching the oligonucleotides to gold nano-particles [Li, Z., Jin, R., Mirkin, C. A., Letsinger, R. L. Nucl. Acids Res. 2002 30, 1558]; R L Letsinger et al., Bioconjugate Chem., 2000, 11(2), 289-291. As a result of this, oligonucleotides modified with terminal thiol groups are in great demand. To the best of our knowledge, viable synthetic procedure for 3-((3-(bis(4-dimethoxytrityl)propyl)disulfanyl)propyl 2-cyanoethyl diisopropylphosphoramidite compound 2 (Scheme 1), which produces target compound in high purity has not been reported. Various interesting applications of this compound motivated us to explore the synthesis and purification.

To summarize, we have developed a very efficient reproducible synthetic and purification protocol for target compound 2 from the compound 1. It is noteworthy that our reaction conditions were reproducible even at multi gram scale (27 g) with the similar purity achieved in small scale. Above mentioned synthetic efforts are example for synthesis of target phosphoramidite, which could be used to generate 5′-thio modifier with the propane spacer/linker.

### BRIEF DESCRIPTION OF DRAWINGS

FIG. 1: ¹H NMR of 3-(dimethoxytrityl) propane-1-thiol compound 3. ¹H NMR was recorded on Bruker 500 MHz NMR spectrophotometer. Chemical shifts are calibrated with deuterated solvent CDC₃ (8 7.26 ppm).

FIG. 2: HPLC purity analysis of 3-(dimethoxytrityl) propane-1-thiol compound 3. Analytical purity of compounds was checked using a Varian Prostar HPLC equipped with ChromSep SS column (4.6×250 mm) and ChromSep Guard-Column OmniSpher 5 C18. Mobile phase: A 95% CH₃CN in 0.1M Triethylammonium acetate (TEAA); B is CH₃CN. Analysis was performed with the linear gradient of increase of B from 0-50% Peaks were detected by UV absorption at 254 nm.

FIG. 3: List of the peaks in the HPLC chromatogram of 3-(dimethoxytrityl) propane-1-thiol compound 3 and the percent purity of each peak.

FIG. 4: ESI/MS spectra of the 3-(dimethoxytrityl) propane-1-thiol compound 3. ESI/MS analysis was carried on Perkin Elmer PE-SCIEX API-150 mass spectrometer.

FIG. 5: ¹H NMR of 3-(dimethoxytrityl) propane phosphorothioamidite compound 4. ¹H NMR was recorded on Bruker 500 MHz NMR spectrophotometer. Chemical shifts are calibrated with deuterated solvent CDC₃ (δ 7.26 ppm).

FIG. 6: ³¹P NMR spectra of 3-(dimethoxytrityl) propane phosphorothioamidite compound 4. ³¹P NMR was recorded on Bruker 202 MHz NMR spectrophotometer. Solvent used for NMR analysis was CDC₃.

FIG. 7: Purity analysis of the 3-(dimethoxytrityl) propane phosphorothioamidite compound 4. Analytical purity of compounds was checked using a Varian Prostar HPLC equipped with ChromSep SS column (4.6×250 mm) and ChromSep Guard-Column OmniSpher 5 C18. Mobile phase: A 95% CH₃CN in 0.1M Triethylammonium acetate (TEAA); B is CH₃CN. Analysis was performed with the linear gradient of increase of B from 0-50% in 20 min. Peaks were detected by UV absorption at 254 nm.

FIG. 8: Table describes list of the peaks in the HPLC chromatogram of 3-(dimethoxytrityl) propane phosphorothioamidite compound 4 and the percent purity of each peak.

FIG. 9: ESI/MS analysis of 3-(dimethoxytrityl) propane phosphorothioamidite compound 4. ESI/MS analysis was carried on Perkin Elmer PE-SCIEX API-150 mass spectrometer.

FIG. 10: ¹H NMR of 3-((3-(bis(4-dimethoxytrityl)propyl)disulfanyl)propyl 2-cyanoethyl diisopropylphosphoramidite compound 2. ¹H NMR was recorded on Bruker 500 MHz NMR spectrophotometer. Chemical shifts are calibrated with deuterated solvent CDC₃ (δ 7.26 ppm).

FIG. 11: ESI/MS analysis spectra of the crude reaction mixture from Trial 3 (2-cyanoethyl N,N′-(diisopropyl)-phosphoramidochloridite, N,N-diisopropylethyl amine, and CH₂Cl₂, 0° C.) indicating the formation of target 3-((3-(bis(4-dimethoxytrityl)propyl)disulfanyl)propyl 2-cyanoethyl diisopropylphosphoramidite compound 2 as potassium salt (+ ion mode; 723.8; M+K) and compound 6 (+ve ion mode, 238.2; M+1; theoretical mass 237.2). The compound 6 is formed due to the side reaction as described earlier. ESI/MS spectral analysis was carried on Perkin Elmer PE-SCIEX API-150 mass spectrometer.

FIG. 12: ³¹P NMR of compound 2. ³¹P NMR was recorded on Bruker 202 MHz NMR spectrophotometer. Solvent; CDC₃/D₂O). H₃PO₄ is used as external standard. Solvent used for NMR analysis is CDCl₃.

FIG. 13: Purity analysis of the 3-((3-(bis(4-dimethoxytrityl)propyl)disulfanyl)propyl 2-cyanoethyl diisopropylphosphoramidite compound 2. Analytical purity of compounds was checked using a Varian Prostar HPLC equipped with ChromSep SS column (4.6×250 mm) and ChromSep Guard-Column OmniSpher 5 C18. Mobile phase: A 80% CH₃CN in 0.1M Triethylammonium acetate (TEAA); B is 90% CH₃CN in 0.1M TEAA. Analysis was performed with the linear gradient of increase of B from 0-50% Peaks were detected by UV absorption at 254 nm.

FIG. 14: Table describing list of the peaks in the HPLC chromatogram of 3-((3-(bis(4-dimethoxytrityl)propyl)disulfanyl)propyl 2-cyanoethyl diisopropylphosphoramidite compound 2 and the percent purity of each peak.

FIG. 15: ESI/MS analysis of 3-((3-(bis(4-dimethoxytrityl)propyl)disulfanyl)propyl 2-cyanoethyl diisopropylphosphoramidite compound 2. ESI/MS analysis was carried on Perkin Elmer PE-SCIEX API-150 mass spectrometer.

FIG. 16: ³¹P NMR of compound 12. This peak in this spectra is corresponding with phosphate moiety. ³¹P NMR was recorded on Bruker 202 MHz NMR spectrophotometer. H₃PO₄ was used as external standard. Solvent used for the NMR analysis was CDC₃.

FIG. 17: HPLC analysis of the compound 12. Analytical purity of compounds was checked using a Varian Prostar HPLC equipped with ChromSep SS column (4.6×250 mm) and ChromSep Guard-Column OmniSpher 5 C18. Mobile phase: A 0.1M Triethylammonium acetate (TEAA); B CH₃CN. Analysis was performed with the linear gradient of increase of B from 0-50% Peaks were detected by UV absorption at 254 nm.

FIG. 18: The Table lists of the peaks in the HPLC chromatogram of 3-((3-(bis(4-dimethoxytrityl)propyl)disulfanyl)propyl 2-cyanoethyl diisopropylphosphoramidite compound 2 and the percent purity of each peak.

FIG. 19: ESI/MS analysis of the compound 12. ESI/MS analysis was carried on Perkin Elmer PE-SCIEX API-150 mass spectrometer. Theoretical MS 788.23, observed MS 787.7 (M-H).

FIG. 20: The coupling efficiency test result of compound 2 on DMT-dT-Icaa CPG compound 11 column at 1 umol scale. Two subsequent couplings of the compound 2 were carried out. The bar graph indicates DMT cation signals as monitored at λ=496 nm. 2^{nd} and 3^{rd} bars indicate trityl cations after two simultaneous additions of compound 2. The coupling efficiency test was performed on Expedite 8909 DNA/RNA synthesizer under standard oligonucleotide synthesis protocol.

### DETAILED DESCRIPTION OF THE INVENTION

Highly satisfactory process was developed when phosphorylation of compound 1 was carried out with N,N′-(diisopropyl)-phosphoramidochloridite and Hunig's base at lower temperature (ice-cold water bath) and simultaneous deoxygenation by purging argon into the reaction mixture (Entry 7, Table 1). Thin layer chromatography showed clean conversion of the starting alcohol 1 to only single desired final product compound 2.

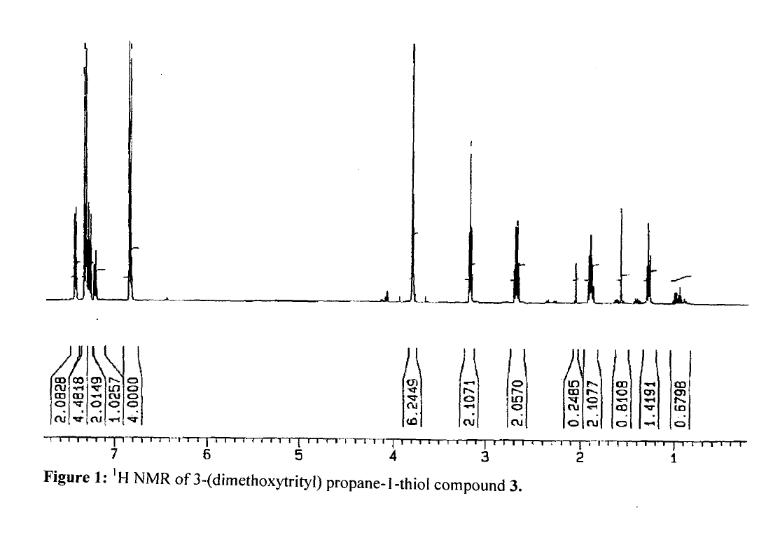

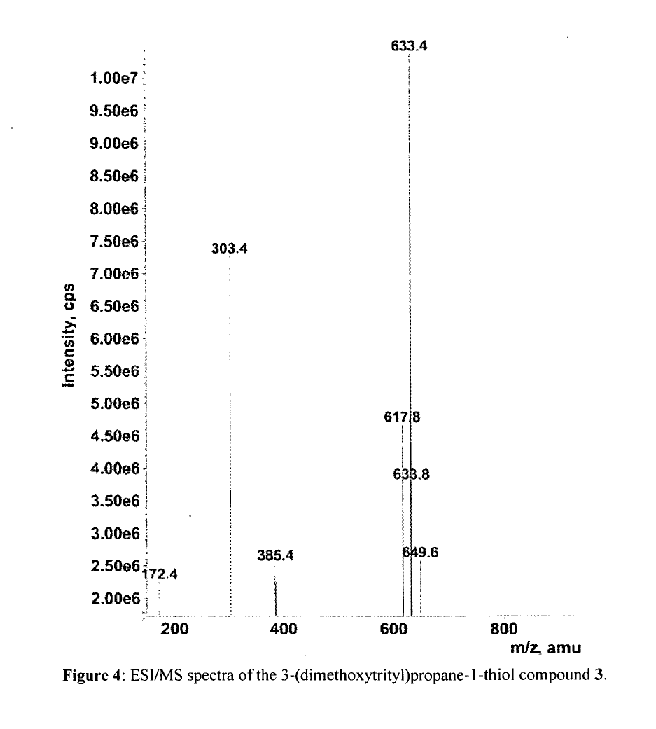

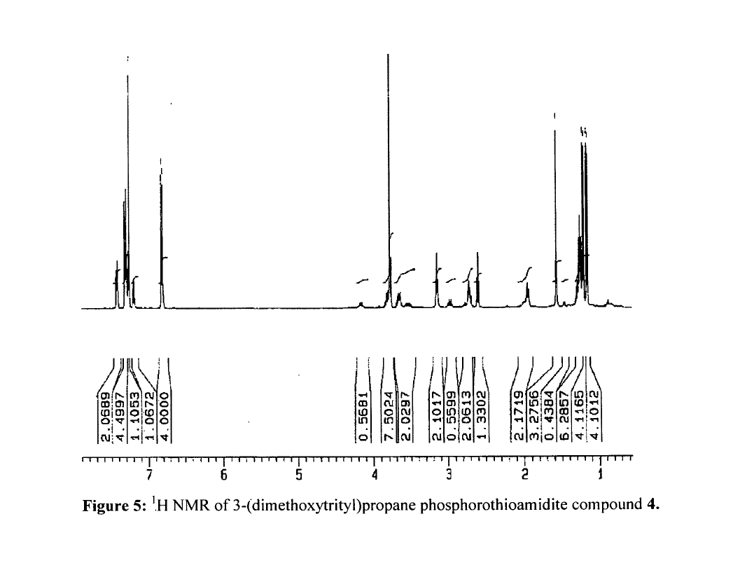

2-cyanoethyl tetraisopropyl phosphoramidite reagent and N,N′-diisopropylamino tetrazolide as a catalyst (Entry 2, Table 1) resulted in clean formation of only the 3-(dimethoxytrityl)propane-phosphorothioamidite compound 4 (FIGS. 4-7) along with minor quantities of compound 3. 31P NMR of compound 3 (FIG. 5) displayed peak at 164 ppm, which confirms the phosphorothioamidite group [Sabbagh, G.; Fettes, K. J.; Gosain, R.; O'Neil, I. A.; Cosstick, R. Nucleic Acids Res. 2004, 32,495-501]. 1H NMR, MS and ³¹P NMR were used to confirm the structures of compound 2 (FIGS. 1-3) and compound 3 (FIGS. 4-7).

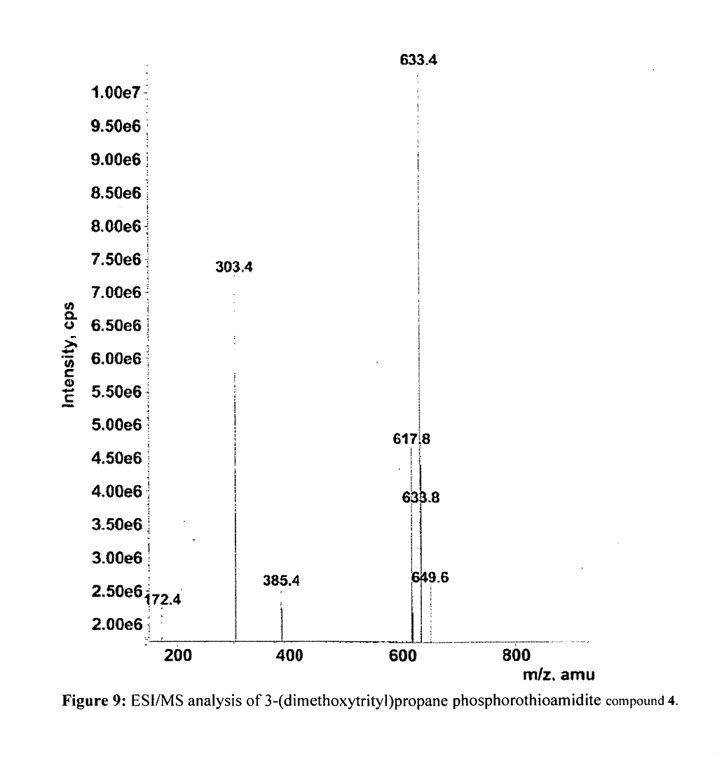

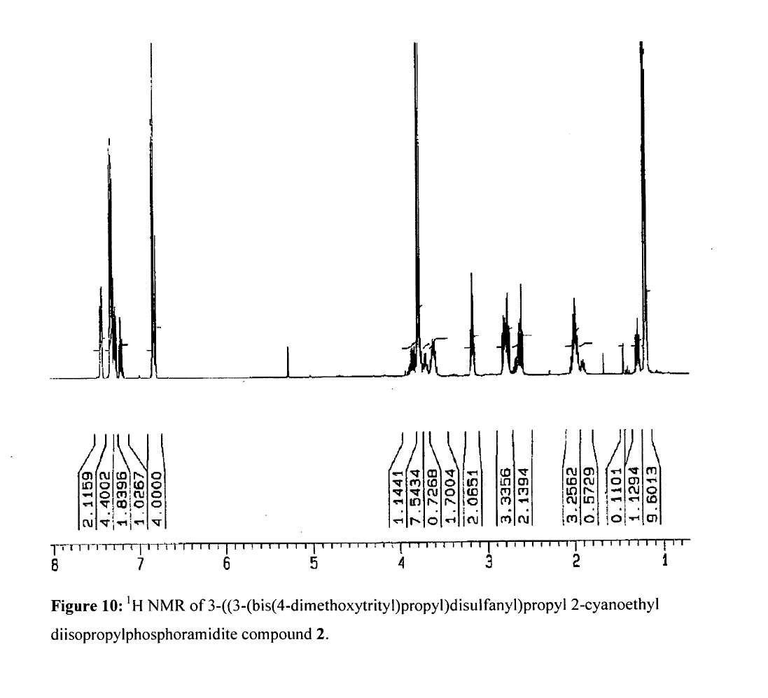

We propose two hypotheses for the formation of compound 3 and compound 4 during these reaction conditions (Entry 1-6, Table 1). The Compound 3-(dimethoxytrityl)propyl)disulfanyl)propan-1-ol, compound 1 is likely unstable during these phosphoramidite reaction conditions and undergoes intramolecular nucleophilic attack of alcohol on to the sulfur atom thereby generating the five membered 1,2-oxathiolane, compound 5 (Scheme 2) and eliminating 3-(dimethoxytrityl)propane-1-thiol, compound 3. The compound 3, which is generated in-situ, converts to corresponding phosphorothioamidite, compound 4. The other plausible mechanism for this could be result from the target phosphoramidite, compound 2, which is formed during the reaction, might be unstable and undergoes intramoleculer nucleophilic attack of phosphorous atom on to sulfur atom to generate cyclic phosphate compound 6 and thereby eliminating 3-(dimethoxytrityl)propane-1-thiol compound 3, which converts to corresponding phosphorothioamidite compound 4. MS analysis of the crude reaction mixture using 2-cyanoethyl N,N′-(diisopropyl)-phosphoramidochloridite, N,N-diisopropylethyl amine, an CH₂Cl₂, 0° C. (Trial 3, Table 1, FIG. 9) showed formation of compound 6 during the reaction. It is important to note here that we never isolated compound 5 and compound 6 in our hands. Based on the formation of compound 2 and compound 3 during phosphoramidite reaction, we speculate these side reactions. Relatively unstable nature of compound 2 opens up two puzzling observations for discussion. It is surprising that corresponding 6-(dimethoxytrityl)hexyl)disulfanyl)hexan-1-ol compound 7 cleanly converts to corresponding phosphoramidite compound 8 using the 2-cyanoethyl tetraisopropyl phosphoramidite and Hunig's base (Scheme 3). This could be due to formation of favorable five or six membered compound 5 and compound 6, respectively, with compound 1 (Scheme 2). Whereas, formation of corresponding larger ring structures possibly will not be energetically favorable and thereby DMT-C6-disulfide alcohol, compound 7 convert to corresponding phophoramidite compound 8 (Scheme 3). Other surprising observation which we would like to discuss is that, the compound 1 is readily converted to succinate salt compound 9 using succinicanhydride, pyridine and 4-dimethylamino pyridine at room temperature (Scheme 3). The compound 9 is further coupled to CPG with long chain alkyl amine linker to generate 3′thiol modifier compound 10 (Scheme 3). We synthesize these compounds 8-10 on regular basis in our laboratories, and these compounds are stable molecules and routinely supplied in the market place by ChemGenes Corp.

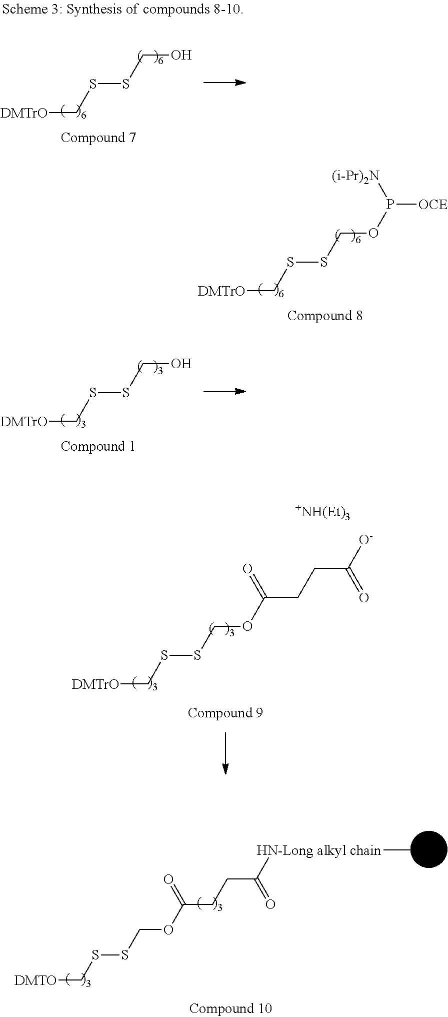

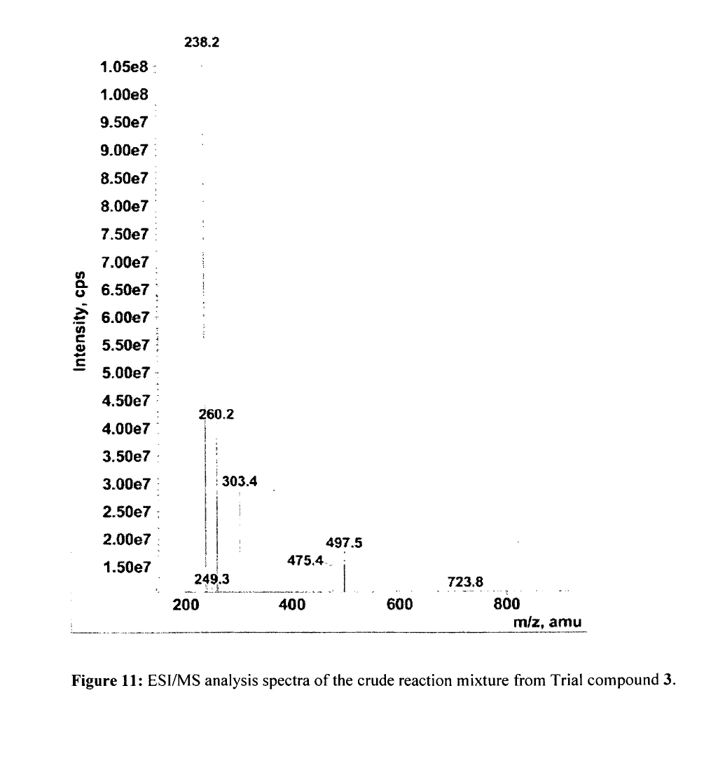

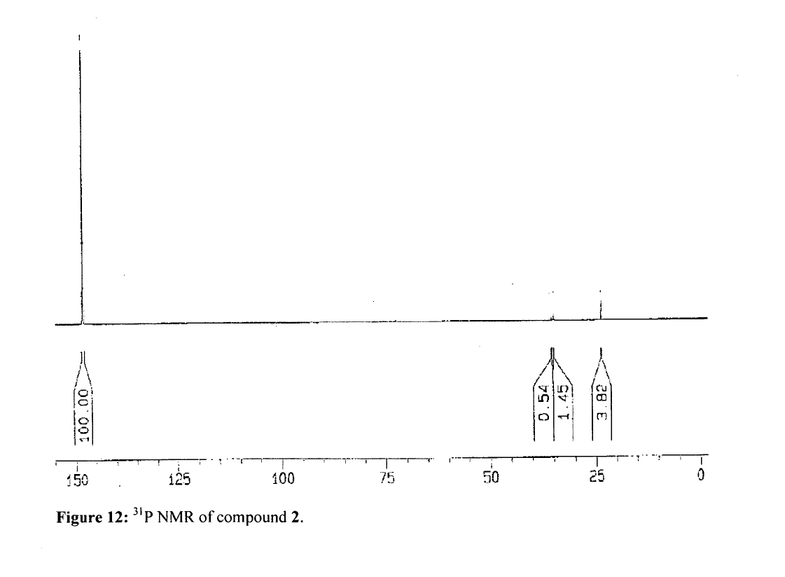

Purity analysis by analytical HPLC in triethylammonium acetate-CH₃CN buffer system was never satisfactory and showed three peaks (FIG. 11, at retention times of 3.42, 6.7 and 8.72 min). Among these peaks the peak at 3.43 min corresponds to the compound 3 and we speculated that the peak at 8.72 min is for the target compound 2. However, thin layer chromatography, ³¹P, ¹H analysis confirmed purity over 94%. This led us to check the stability of the target compound in the triethylammonium acetate buffer. As we anticipated we did see breakdown of the compound 2 to compound 3 in triethylammonium acetate buffer. These results are in accordance with HPLC analysis results.

We envision that this invention could be used for a vast number of all other possible protecting groups such as mild base labile protecting groups such as levulinyl replacing the DMT group in the instant example, compound 2, a large number acid labile protecting groups in place of DMT group in the instant example, compound 2, such as large variety of trityl derivatives; monomethoxy trityl (MMT), trimethoxytrityl (TMT) protecting groups as described in Fisher, E. F. et. al [Fisher, E. F., Caruthers, M. H. Nucleic acid res. 1983, 5, 1589] as well as photo labile protecting groups replacing DMT in the instant example, compound 2, such as NPPOC (3′-Nitrophenylpropyloxycarbonyl) [Pirrung, M. C., Wang, L.; Montague-Smith, M. P. Org. Lett., 2001, 3 (8), 1105], NVOC (6-nitroveratryloxycarbonyl), MeNPOC (a-methyl-2-nitropiperonyloxycarbonyl), and MNPPOC (2-(3,4-methylenedioxy-6-nitrophenyl)propoxycarbonyl) [Berroy, P., Viriot, M. L., Carre, M. C. Sensors and Actuators B 2001 74 186]. In addition, we could also use this procedure to generate various phosphoramidite derivatives, which have various alkyl and aryl groups in place of isopropyl groups and cyanoethyl group. Scope of protecting groups and various modifications of phosphoramidite modifications for the synthesis of DNA and RNA have been elegantly covered by Caruthers et. al., Process For Preparing Polynucleotides; M. H. Caruthers, Mark Matteucci, U.S. Pat. No. 4,4458,066, Jul. 3, 1984, Koster et al., Process For the preparation of Oligonucleotides, Hubert Koster, Nanda Sinha, U.S. Pat. No. 4,725,677, Feb. 16, 1988, Rosch et. al., Oligonucleotide Analogs with terminal 3′-3′ or 5′,5′ internucleotide linkages; Hannelore Rosch, Anja Frohlich, Jose Flavio, Ramalle-Ortiga, Mathias Montenarh, Harmut Seliger, U.S. Pat. No. 5,750,669, May 12, 1998; Duplaa et al., Process for the preparation of ribonucleic acid (RNA) using a novel deprotection reagent; Ann-Marie Duplaa, Dididier Gasparutto, Thierry Livache, Didier Molka, Robert Toule; U.S. Pat. No. 5,552,539.

It is possible to incorporate the internucleotide linkages in the oligonucleotides of our invention which can be represented by formula Ia and Ib.

Z—P=W 1a

Z′—P=W″ 1b

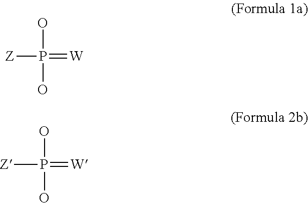

W and W′ could be independent of one another, oxygen or sulfur O⁻, S⁻;

Z and Z′ are independent of one another and could be;

C1-C-18 alkoxy, C1-18 alkyl; NHR3 with R3=C1-C18 alkyl or C1-C4 alkoxy-C1-C6-alkyl; NR3R4 in which R3 is as defined above and R4 is C1-C18 alkyl, or in which R3 is as defined above and R4 is C1-C18-alkyl, or in which R3 and R4 form together with the nitrogen atom carrying them, a 5-6 membered heterocyclic ring which can additionally contain another hetero atom from the series O, S and N;

Further more it is possible to have the linkage with oligonucleotide represented by formula II, which could lead to oligonucleotides of our claims;

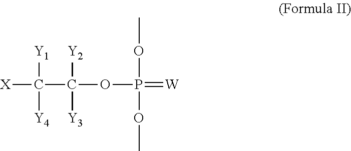

In such examples Y can be singly or multiply as hydrogen, methyl, ethyl, Z can be an electron attracting group, for example, halogen, such as fluorine, chlorine, or bromine, CN, NO₂, SO₂. Z can be aromatic such as phenyl thio, phenyl sulfoxy, phenylsulfonyl. Such phenyl ring groups can be substituted with halogen, CN, NO₂. It is also possible for X—C—(Y₁, Y₂)- in formula II to be replaced by one of the groups such as CF₃, CCl₃ or CBr₃.

The C-3 disulfide ligand attached to an oligonucleotide could also carry phosphotriester moiety. Such methodologies have been reviewed elegantly by M. H. Caruthers; Synthesis and Application of DNA and RNA, Academic Press, Inc., 1983, pp 47-94. Additionally p-methyl group in oligonucleotides and p-alkoxy groups have been shown to possess excellent biological properties, Kathleen A. Gallo et. Al., Nucleic Acids Research, Vol. 14, No. 18, 7405-7419; Oligonucleotide phosphsate triesters; Dale, Roderic M. K., Arrow, Amy, Srivastava, Suresh C., Raza, Syed K., U.S. Pat. No. 6,015,886.

### Example 1

### Optimized synthetic protocol for the synthesis of 3-((3-(bis(4-dimethoxytrityl)propyl)disulfanyl)propyl 2-cyanoethyl diisopropylphosphoramidite

Compound 2 (Entry 7, Table 1)

DMT-C3 disulfide alcohol compound 1 (27 g, 55 mmol) was dried by coevaporation with anhydrous CH₃CN (1×100 mL) and dried over-night on high vacuum pump then dissolved in anhydrous THF (270 mL). To this was added N, N′-diisopropylethylamine (48.5 mL) and cooled in an ice cold water bath. After bubbling the argon for 30 min, 2-cyanoethyl N,N′-(diisopropyl)phosphoramidochloridite (13.67 ml, 61.2 mmol) was added under complete argon atmosphere and the reaction mixture was stirred in ice-cold water bath for 1 h, whereupon it was diluted with EtOAc (500 mL). The organic phase was washed with saturated aqueous NaHCO₃ (100 mL), and saturated aqueous NaCl (100 ml). The combine aqueous phase was back-extracted with EtOAc (250 mL). The combined organic phase was evaporated to dryness, and the resulting residue was quickly purified by very short pad silica gel column chromatography (8:1:1 Heane:EtOAc:Triethylamine, v/v/v) to afford target amidite compound 2 (26 g, 69%) as a white solid material. R_{f}=0.35 (8:1:1 Heane:EtOAc:Triethylamine, v/v/v); MS m/z C₃₆H₄₉N₂O₅PS₂.Na ([M+Na]⁺ 707.28, C₃₆H₄₉N₂O₅PS₂.Na+ calcd 707.9); ¹H NMR (CDC₃) 7.41-7.46 (m, 2H), 7.25-7.35 (m, 6H), 7.20-7.23 (m, 114), 6.79-6.85 (m, 4H), 3.81-3.85 (m, 2H), 3.70-3.80 (s, 8H), 3.58-3.62 (m, 2H), 3.13-3.19 (m, 2H), 2.75-2.83 (m, 4H), 2.58-2.66 (m, 2H), 1.95-2.04 (m, 4H), 1.17-1.22 (m, 12H). ³¹P NMR (CDC₃) δ 148.31.

Physico Chemical Data for Byproduct Formed During Various Trials (Trials 1-6, Table 1 & Scheme 2):

### 3-(dimethoxytrityl)propane thiol compound 3

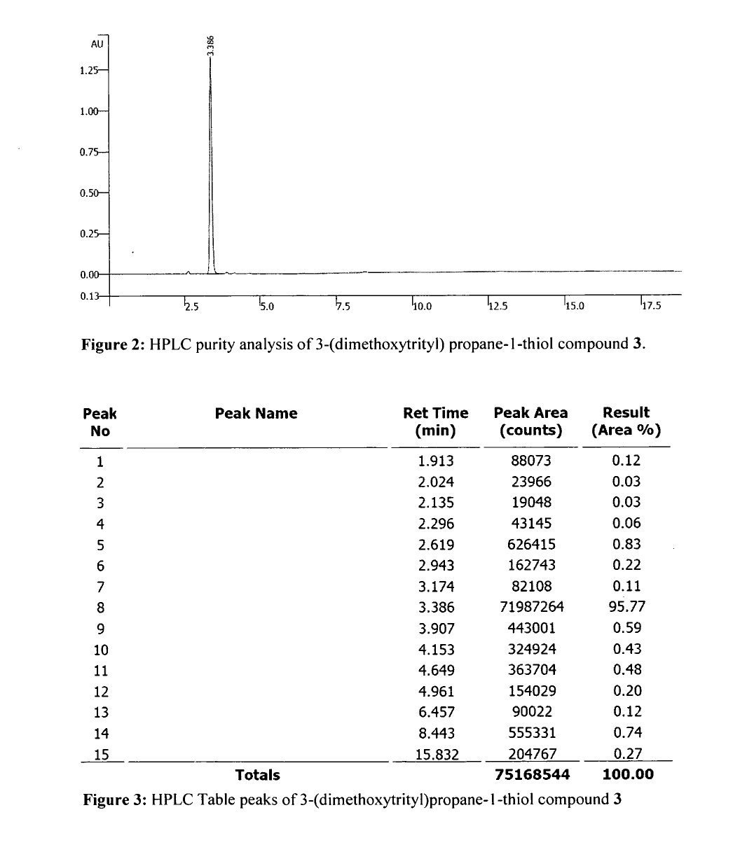

R_{f}=0.45 (8:1:1 Heane:EtOAc:Triethylamine, v/v/v); MS (FIG. 3) m/z C₂₄H₂₆O₃S.Na (D[M+Na]⁺ 417.16, C₂₄H₂₆O₃S.Na+ calcd 417.4); ¹H NMR (FIG. 1, CDC₃) 7.41-7.46 (m, 2H), 7.18-7.34 (m, 6H), 7.18-7.23 (m, 1H), 6.80-6.85 (m, 4H), 3.79 (s, 3H), 3.77 (s, 3H), 3.16 (t, 2H, J=5.9 Hz), 2.64-2.69 (m 2H), 1.85-1.92 (m, 2H). Purity analysis by analytical HPLC (FIG. 2) retention time at 3.39 min (purity >95%).

### 3-(dimethoxytrityl)propane 2-cyanoethyl diisopropylthiophosphoramidite compound 4

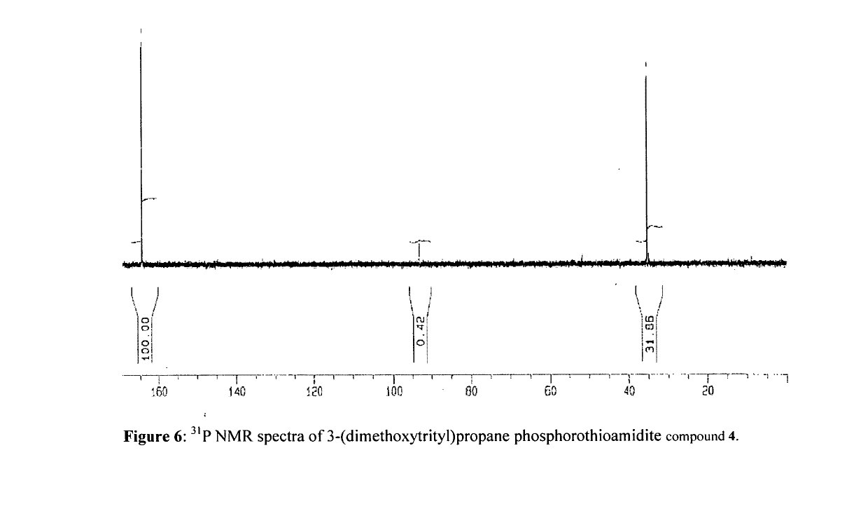

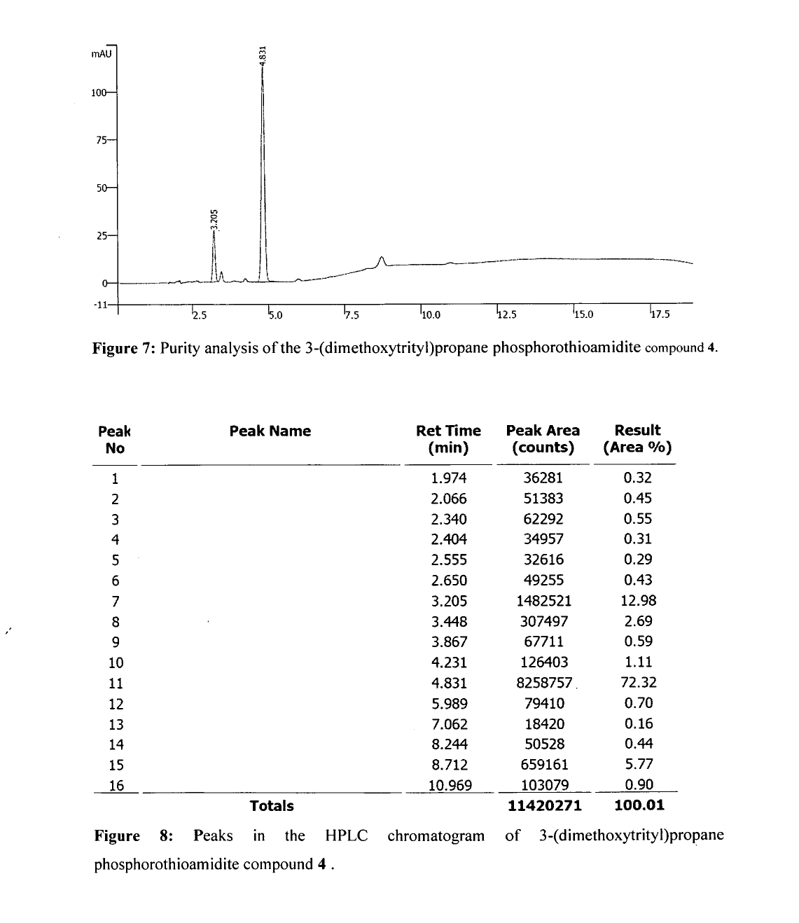

R_{f}=0.35 (8:1:1, Hexane:EtOAc:Triethylamine, v/v/v); MS (FIG. 7, m/z C₃₃H₄₃N₂O₄PS.Na ([M+Na]⁺617.27, C₃₃H₄₃N₂O₄PS.Na⁺ calcd 617.8); ¹H NMR (FIG. 4, CDC₃) 7.39-7.44 (m, 2H), 7.18-7.34 (m, 6H), 7.18-7.23 (m, 1H), 6.80-6.84 (m, 4H), 3.75-3.83 (m, 8H), 3.64-3.68 (m, 2H), 3.13-3.17 (m, 2H), 2.69-2.74 (m, 2H), 2.57-2.62 (m, 2H), 1.92-1.97 (m 2H) 1.14-1.21 (m 12H). ³¹P NMR (FIG. 5, CDC₃) δ 164.492. Purity analysis by analytical HPLC (FIG. 6) retention time 4.83 min (purity >95%).

### Coupling of compound 2 to DMT thymidine-3′-succinyl-LCAA-CPG compound 11

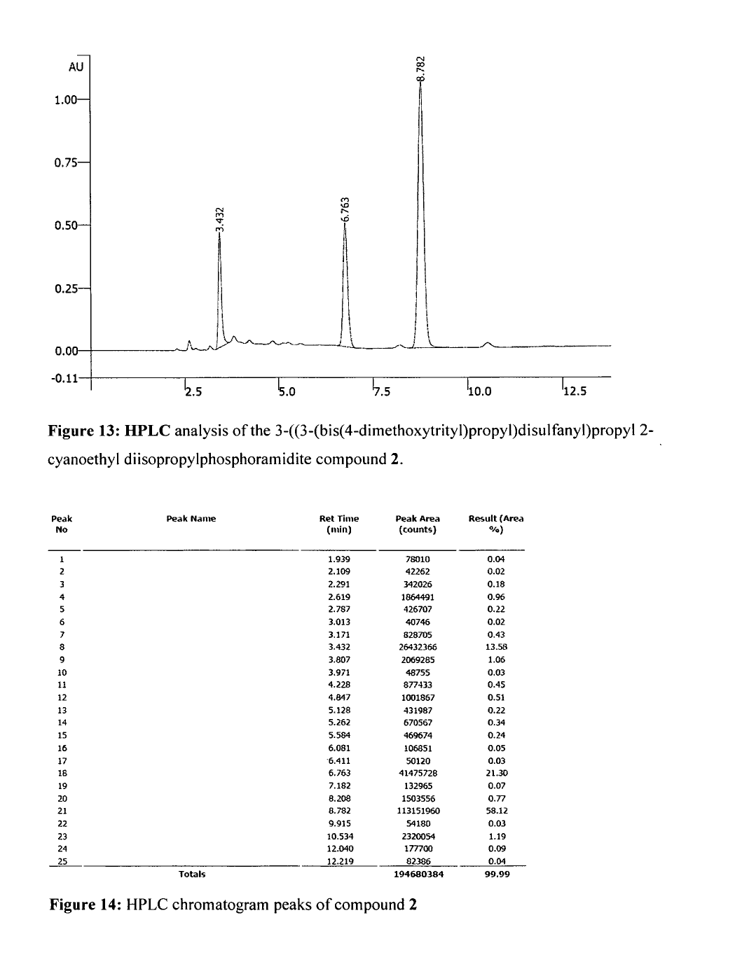

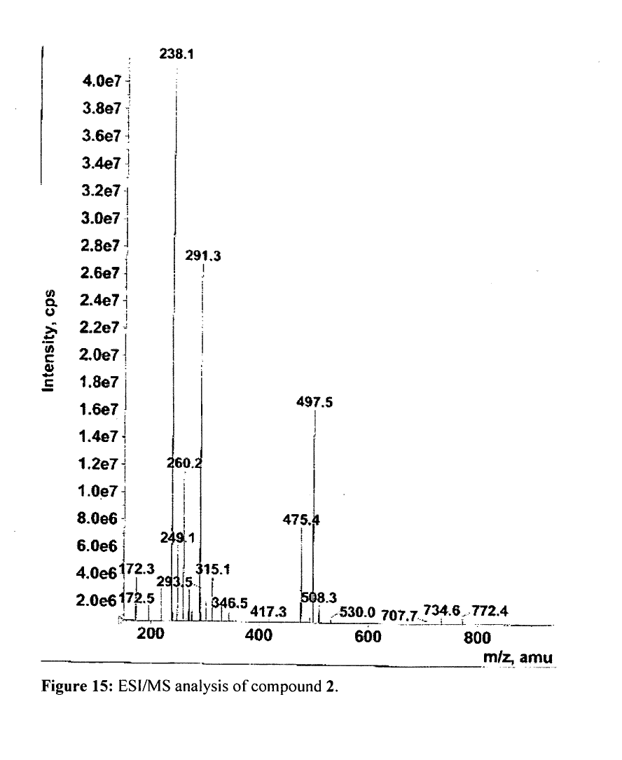

The coupling efficiency of the phosphoramidite compound 2 was evaluated using two strategies viz, a) manual coupling in 30 umol scale, b) coupling on Expedite 8909 DNA/RNA synthesizer on 1 umol scale. In both cases we choose to couple it to DMT-dT-3′-succinyl-Lcaa-CPG compound 11 (Scheme 4). In manual coupling, we used standard oligonucleotide coupling protocols (3% TCA in DCM for deblocking, Ethylthio tetrazole for the coupling) except for oxidation conditions. We have used two different concentration of ¹₂ in THF/H₂O/pyridine viz 0.01 and 0.02 M, to see the effect of I₂ in oxidizing sulfur. Then, CPG support was treated with MeOH/NH₃ at 37° C. for 4 hr followed by evaporation and precipitation in hexane. Analytical data indicated formation of same products during these two different reaction conditions. The ESI/MS analysis of the resulting precipitated product showed formation of desired coupled product compound 12 (Scheme 4, FIG. 15). However, HPLC chromatogram of this reaction displayed 3 peaks with retention time of 1.40, 1.50 and 6.72 mins (FIG. 14). From the mass analysis, we speculate that they are unreacted thymidine related derivatives and more analysis on this is under progress. However, these results show stability and capability of compound 2 during the oligonucleotide synthesis.

Based on these data it is anticipated that during ammonia deprotection of the C-3 disulfide coupled linker to thymidine, compound 12 would have a tendency to cause cleavage of thymidine and in case of coupling and deprotection of protecting groups of oligonucleotides, compound 13 & compound 14 would have tendency to cause some cleavage of oligonucleotides (compound 11 replacing thymidine with an oligonucleotide). We therefore envisage using of milder deprotection conditions to optimize high yield synthesis of various oligonucleotides attached to C-3 disulfide linkage, compounds 13, 14 & 15.

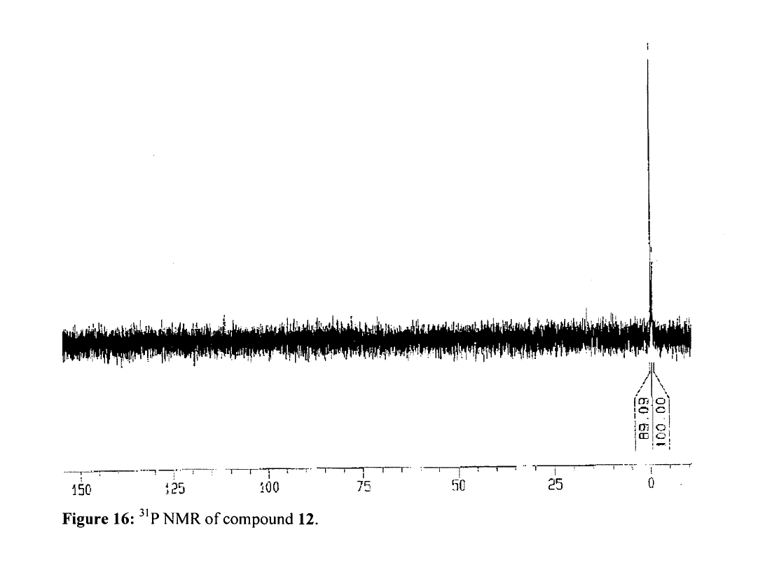

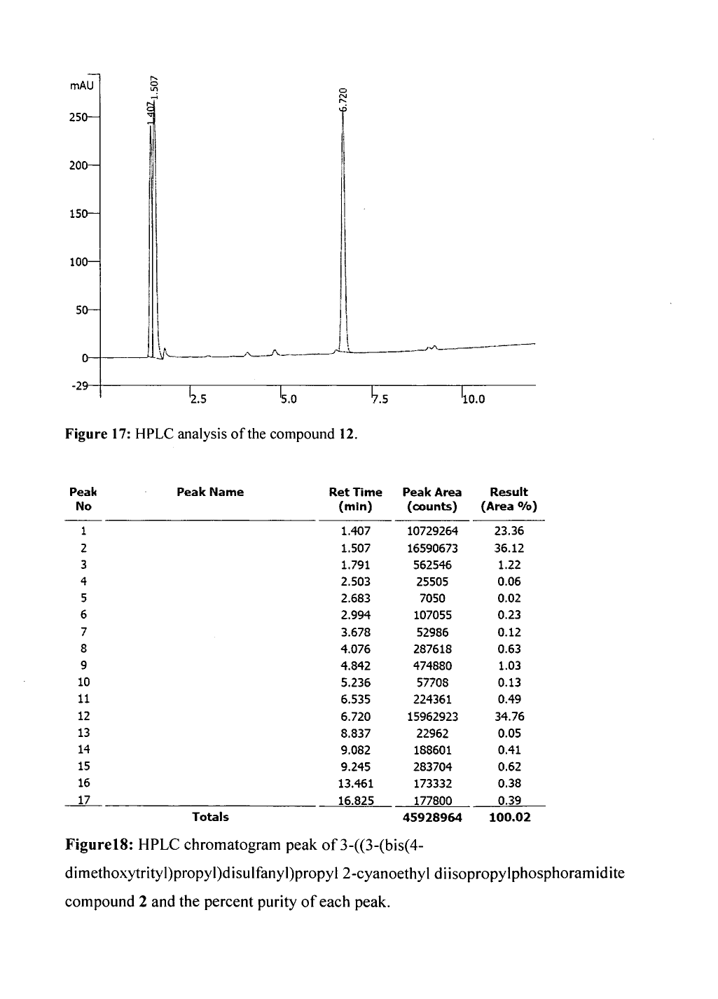

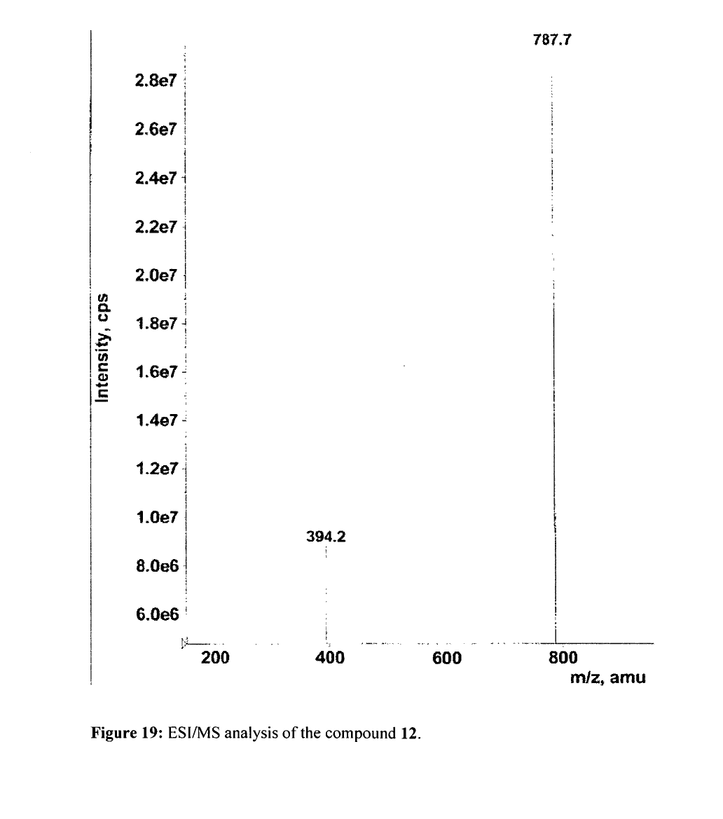

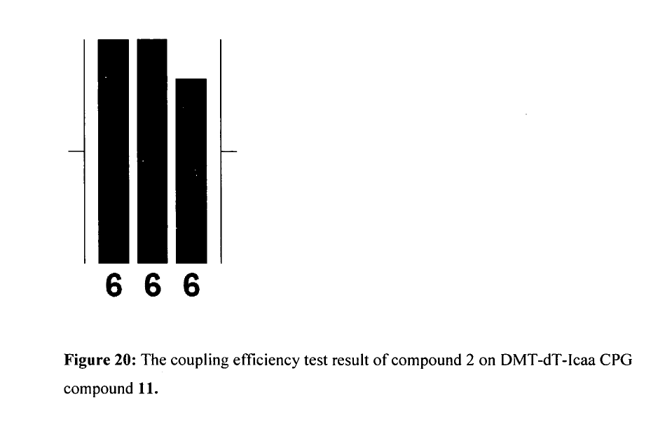

In the other method, DMT-T-Icaa-CPG (compound 11) loaded column was used and synthesis was performed on Expedite 8909 DNA/RNA synthesizer at 1 umole scale. We observed 96% over all coupling efficiency after two consecutive couplings with 2 min coupling time (FIG. 16). As indicated in the FIG. 16, first coupling was satisfactory and further coupling of compound 5 on itself did not give satisfactory yield.

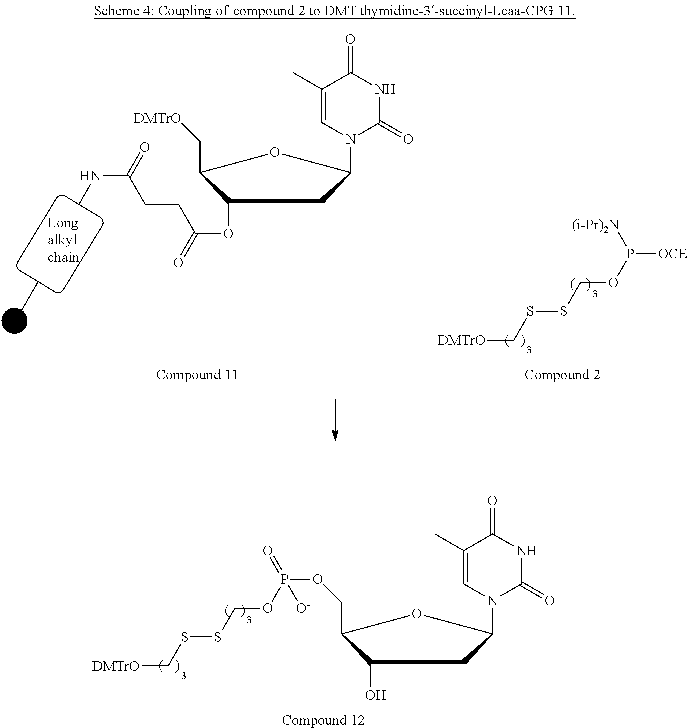

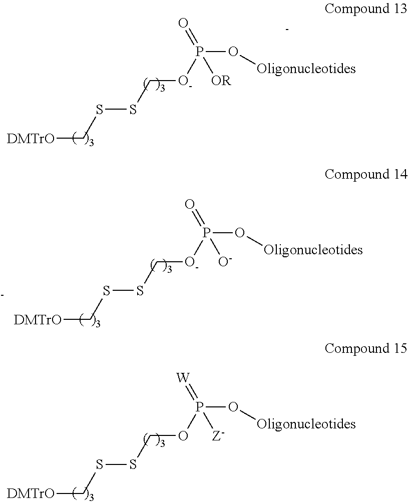

Having described the invention, and given the illustrative examples, we claim:

1. A phosphoramidite derivative of structure 1, 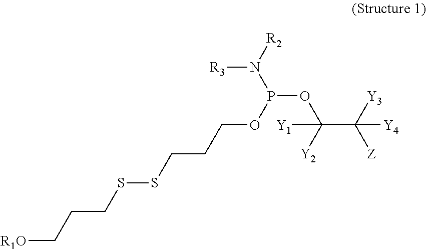
where in, R₁ is one of {acid labile hydroxyl protecting group; triphenyl methyl, monomethoxy triphenyl (MMT), trimethoxytriphenyl (TMT), di-p-anisylphenylmethyl, p-fluorophenyl-1-naphthylphenylmethyl, p-anisyl-1-naphthylphenylmethyl, di-o-anisyl-1-naphthylmethyl, di-o-anisylphenylmethyl, p-tolyldiphenylmethyl, di-p-anisylphenylmethyl, di-o-anisyl-1-naphthylmethyl, di-p-anisylphenylmethyl,
di-o-anisylphenylmethyl or p-tolyl diphenyl methyl, tetrahydropyranyl and methoxytetrahydropyranyl.
is a mild base deprotecting group,
is a photo cleavable protecting groups, NPPOC (3′-Nitrophenylpropyloxycarbonyl), NVOC (6-nitroveratryloxycarbonyl), MeNPOC (a-methyl-2-nitropiperonyloxycarbonyl), MNPPOC (2-(3,4-methylenedioxy-6-nitrophenyl)propoxycarbonyl)};
R₂ is an alkyl group or an aromatic group;
R₃ is an alkyl group or an aromatic group; and
each of Y₁, Y₂, Y₃, Y₄ is a hydrogen radical or primary, secondary or tertiary alkyl groups.

2. Process of synthesis of compound 2 from compound 1, 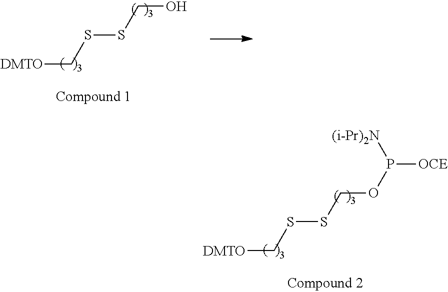
(a) comprising the steps of;
(b) mixing compound 1 in anhydrous organic solvent capable of forming an azeotrope with residual water in the compound 1,
(c) evaporating under high vacuum pump;
(d) drying compound 1 under high vacuum;
(e) mixing compound 1 with anhydrous non-protic organic solvent;
(f) cooled in a suitable cooling bath under anhydrous conditions;
(g) adding a tertiary amine;
(h) purging with inert gas until all the oxygen/air was removed;
(i) adding 2-cyanoethyl N,N′-(diisopropyl)-phosphoramidochloridite reagent slowly while purging of inert gas into the reaction container is on-going;
(j) after the addition of phosphitylating reagent the reaction mixture under anhydrous conditions under cold conditions until all starting material was consumed;
(k) quenching the reaction with appropriate quantity of a solution of saturated aqueous inorganic bicarbonate;
(l) extracting the reaction mixture with non polar organic solvent;
(m) washing the organic layer with saturated aqueous brine solution;
(n) passing the organic layer over a drying agent;
(o) concentrating the organic layer under low vacuum;
(p) charging crude product using organic solvent mixture consisting of 1% or more of a tertiary amine to a silica gel column of appropriate dimension;
(q) eluting the desired product quickly eluting using the same solvent as used for charging compound;
(r) concentrating pure fractions to dryness under low vacuum until it is free from all organic solvents and moisture;
(s) sealing the pure product sealed under inert gas
(t) Storing at −20 C.

3. The compound 2 of purity greater than 94% by 31 P NMR.
